(19) United States
(12) Patent Application Publication
(10) Pub. No.: US 2013/0258973 A1
(43) Pub. Date: Oct. 3, 2013

(54) COLLISION RESOLUTION AMONG TRANSMISSION SCHEDULES OF UPLINK CONTROL INFORMATION (UCI) USING CHANNEL STATE INFORMATION (CSI) PROCESS

(71) Applicant: SHARP LABORATORIES OF AMERICA, INC., Camas, WA (US)

(72) Inventors: Ahmad Khoshnevis, Portland, OR (US); Shohei Yamada, Camas, WA (US)

(73) Assignee: Sharp Laboratories of America, Inc., Camas, WA (US)

(21) Appl. No.: 13/853,931

(22) Filed: Mar. 29, 2013

Related U.S. Application Data
(63) Continuation-in-part of application No. 13/436,530, filed on Mar. 30, 2012.
(60) Provisional application No. 61/707,835, filed on Sep. 28, 2012.

(51) Int. Cl. H04W 72/12

(52) U.S. Cl. CPC H04W 72/1226
USPC 370/329

(57) ABSTRACT

A method for reporting uplink control information (UCI) on a user equipment (UE) is described. A channel state information (CSI) process index is set to a value received in a CSI process configuration for each serving cell if a message the UE received includes the CSI process configuration for the serving cell. A CSI process index is set to a default value if a message the UE received does not include a CSI process configuration for the serving cell.

### RELATED APPLICATIONS

This application is a continuation-in-part of U.S. patent application Ser. No. 13/436,530, filed Mar. 30, 2012, for “COLLISION RESOLUTION AMONG TRANSMISSION SCHEDULES OF UPLINK CONTROL INFORMATION (UCI),” which is hereby incorporated herein by reference.

This application claims the benefit of U.S. Provisional Patent Application Ser. No. 61/707,835, for “COLLISION RESOLUTION AMONG TRANSMISSION SCHEDULES OF UPLINK CONTROL INFORMATION (UCI) USING CHANNEL STATE INFORMATION (CSI) PROCESS,” which is hereby incorporated herein by reference.

### TECHNICAL FIELD

The present invention relates generally to wireless communications and wireless communications-related technology. More specifically, the present invention relates to systems and methods collision resolution among transmission schedules of uplink control information (UCI) using channel state information (CSI) process.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station (e.g., eNode B) may be a fixed station that communicates with mobile stations.

Various signal processing techniques may be used in wireless communication systems to improve efficiency and quality of wireless communication. Benefits may be realized by improved methods for reporting uplink control information (UCI) by a wireless communication device.

### BRIEF DESCRIPTION OF THE DRAWINGS

FIG. 1 is a block diagram illustrating a wireless communication system that may utilize coordinated multipoint (CoMP);

FIG. 2 is a block diagram illustrating one configuration of CSI-RS resources, measurements and reporting in a user equipment (UE) serving cell;

FIG. 3 is a block diagram illustrating a wireless communication system using uplink control information (UCI) multiplexing;

FIG. 4 is a block diagram illustrating the layers used by a user equipment (UE);

FIG. 5 illustrates various components that may be utilized in a user equipment (UE);

FIG. 6 illustrates various components that may be utilized in an eNode B;

FIG. 7 is a flow diagram of a method for reporting UCI on a UE;

FIG. 8 is a block diagram illustrating one configuration of a CSI Process configuration IE; and

FIG. 9 is a block diagram illustrating CSI-RS configurations for multiple serving cells.

### DETAILED DESCRIPTION

A method on a user equipment (UE) is described. A channel state information (CSI) report to be dropped is determined from among multiple CSI reports of physical uplink control channel (PUCCH) reporting type of a same priority corresponding to multiple serving cells. One of the CSI reports with a CSI process index received in a CSI process configuration corresponds to a serving cell configured with transmission mode 10 and another of the CSI reports corresponds to a serving cell configured with one of transmission mode 1 through 9.

A method on a base station is also described. It is determined that a user equipment (UE) determines a channel state information (CSI) report to be dropped from among multiple CSI reports of physical uplink control channel (PUCCH) reporting type of a same priority corresponding to multiple serving cells. One of the CSI reports with a CSI process index received in a CSI process configuration corresponds to a serving cell configured with transmission mode 10 and another of the CSI reports corresponds to a serving cell configured with one of transmission mode 1 through 9.

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9, Release-10 and Release-11). However, the scope of the present disclosure should not be limited in this regard. At least some aspects of the systems and methods disclosed herein may be utilized in other types of wireless communication systems.

In LTE Release-11, the use of coordinated multipoint (CoMP) transmission and reception are major enhancements. In coordinated multipoint (CoMP) transmission, a user equipment (UE) may be able to receive downlink signals from multiple geographically separated antennas (referred to herein as points). A point may be a set of geographically co-located antennas. A point may also be referred to as a site. Points may be located on or connected to the same base station or different base stations. Furthermore, uplink transmissions by the user equipment (UE) may be received by multiple points. Those points that transmit on the downlink to the user equipment (UE) may be referred to as transmission points. Those points that receive transmissions on the uplink from a user equipment (UE) may be referred to as reception points.

A point may be capable of both transmission and reception. In general, “point” refers to both transmission points and reception points. It is not necessary to use the same set of points for transmission to and reception from a given user equipment (UE). A subset of points participating in downlink transmission (to a user equipment (UE)) may be the same as or different from a subset of points participating in uplink reception (from the user equipment (UE)). Sectors of the same site may correspond to different points. A set of points that are involved in downlink transmission or uplink reception may change from one subframe to another.

An antenna port may be defined such that the channel over which a symbol on the antenna port is conveyed can be inferred from the channel over which another symbol on the same antenna port is conveyed. There may be one resource grid (time-frequency) per antenna port. Antenna ports can realize multiple layers for a multiple-input and multiple-output (MIMO) system. The points may be transparent to the user equipment (UE). To a user equipment (UE), antenna ports are distinguishable. An antenna port may be realized by an antenna or set of antennas in one point or a set of antennas in different points. However, points are distinguishable from the perspective of an eNode B. Therefore, in a transmission from a point to the user equipment (UE), from the perspective of the eNode B, the eNode B knows which point(s) are used for an antenna port participating in the transmission.

By coordinating the downlink transmissions from each point to the user equipment (UE), the downlink performance can be significantly increased. Likewise, by coordinating the uplink reception at multiple reception points, significant improvement in the uplink performance can be achieved. In coordinated multipoint (CoMP) transmissions, the channel state information (CSI) of each coordinated cell may be reported separately or jointly with the same format as Release-10 or new formats.

The use of coordinated multipoint (CoMP) transmission and/or reception may increase uplink and downlink data transmission rates while ensuring consistent service quality and throughput on LTE wireless broadband networks and 3G networks. Coordinated multipoint (CoMP) transmission and/or reception may be used on both the uplink and the downlink.

The term “simultaneous” may be used herein to denote a situation where two or more events occur in overlapping time frames. In other words, two “simultaneous” events may overlap in time to some extent, but are not necessarily of the same duration. Furthermore, simultaneous events may or may not begin or end at the same time.

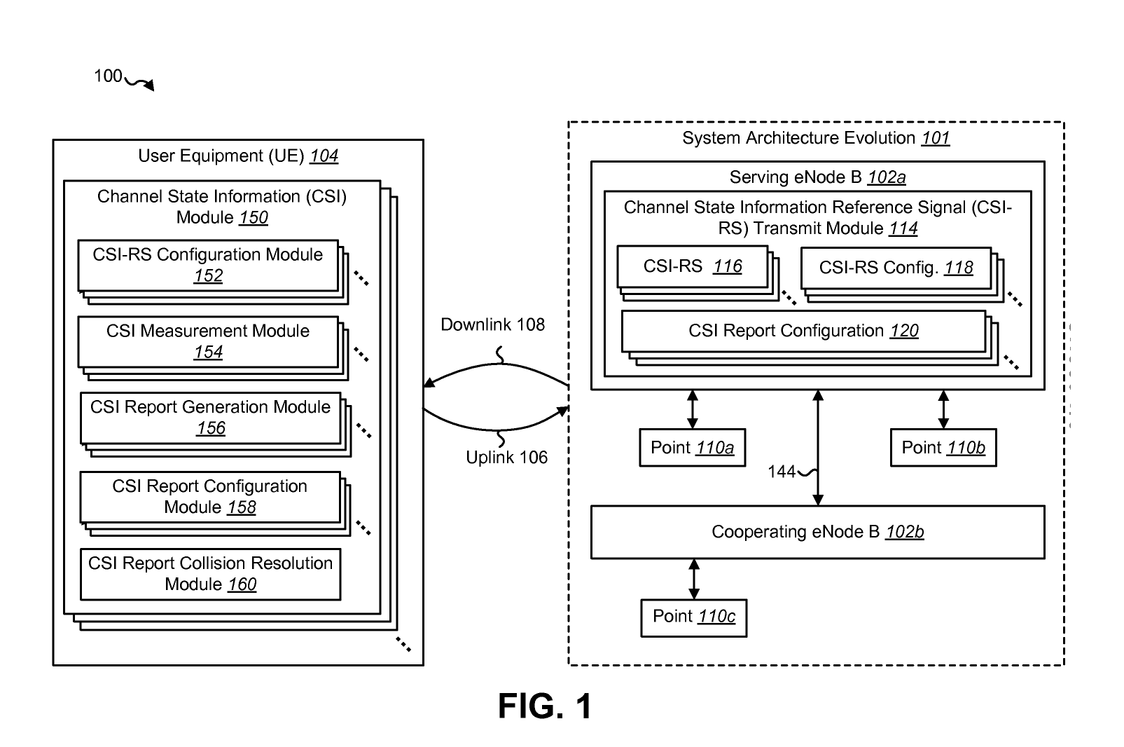

FIG. 1 is a block diagram illustrating a wireless communication system 100 that may utilize coordinated multipoint (CoMP). The wireless communication system 100 may include a serving eNode B 102a and a cooperating eNode B 102b as part of a system architecture evolution 101. The system architecture evolution 101 is a flat IP-based network architecture designed to replace the CPRS Core Network. In one configuration, the system architecture evolution 101 may be referred to as a core network.

The eNode B 102 may have a channel state information reference signal (CSI-RS) transmit module 114. The CSI-RS transmit module 114 may include channel state information reference signals (CSI-RS) 116, channel state information reference signal (CSI-RS) configurations 118 and channel state information (CSI) report configurations 120. The eNode B 102 may send the CSI-RS 116 to the user equipment (UE) 104, for instance, to be measured. Note, as used herein CSI-RS may refer to a single CSI-RS and/or multiple CSI-RSs.

The CSI-RS transmit module 114 may generate CSI-RS configurations 118. The eNode B 102 may then send the CSI-RS configuration 118 to the user equipment (UE) 104. In this way, the user equipment (UE) 104 may use the received CSI-RS configurations 118 to detect and process the CSI-RS 116 transmitted to it. For example, the user equipment (UE) 104 may store the received CSI-RS configurations 118 in the CSI-RS configuration module 152.

The eNode B 102 may send the channel state information (CSI) report configurations 120 to the user equipment (UE) 104 so that the user equipment (UE) 104 may generate CSI reports to be sent back to the eNode B 102. For example, each channel state information (CSI) report configuration 120 may also include information about which CSI-RS(s) 116 should be used to be reported. For example, the user equipment (UE) 104 may store the received CSI report configurations 120 in the CSI report configuration module 158.

An eNode B 102 is a physical structure that may include multiple antennas. Some of the antennas may be co-located with an eNode B 102 and other antenna ports may be geographically separated from an eNode B 102. Both the co-located antennas and the geographically separated antennas may be referred to as points 110. Some of the points 110a-b may be associated with the serving eNode B 102a while other points 110c may be associated with a cooperating eNode B 102b. The eNode Bs 102 may use the points 110 to coordinate downlink 108 transmission to and uplink 106 reception from a user equipment (UE) 104. If a point 110c is connected to a cooperating eNode B 102b, there may be a backhaul interface 144 connecting the cooperating eNode B 102b to the serving eNode B 102a.

A point 110 may be an antenna and or antenna port associated with a base station. A base station may be referred to as an access point, a transmission point, a Node B, an eNode B, a transmission node, a node or some other terminology. A point 110 may be collocated with a base station or geographically separated from the base station. Likewise, a user equipment (UE) 104 may be referred to as a mobile station, a subscriber station, an access terminal, a remote station, a user terminal, a terminal, a handset, a subscriber unit, a wireless communication device or some other terminology.

Communication between a user equipment (UE) 104 and an eNode B 102 may be accomplished using transmissions over a wireless link, including an uplink 106 and a downlink 108. The uplink 106 refers to communications sent from a user equipment (UE) 104 to a device in the system architecture evolution 101 (e.g., an eNode B 102). The downlink 108 refers to communications sent from the system architecture evolution 101 (e.g., an eNode B 102) to a user equipment (UE) 104. An eNode B 102 may use different combinations of points 110 to send downlink 108 signals to a user equipment (UE) 104 and receive uplink 106 signals from the user equipment (UE) 104.

In general, the communication link may be established using a single-input and single-output (SISO), multiple-input and single-output (MISO), single-input and multiple-output (SIMO) or a multiple-input and multiple-output (MIMO) system. A MIMO system may include both a transmitter and a receiver equipped with multiple transmit and receive antennas. Thus, a base station may have multiple antennas (or points 110) and a user equipment (UE) 104 may have multiple antennas (not shown). In this way, a base station and a user equipment (UE) 104 may each operate as either a transmitter or a receiver in a MIMO system. One benefit of a MIMO system is improved performance if the additional dimensionalities created by the multiple transmit and receive antenna ports realized by the multiple transmit and receive antennas are utilized.

In 3rd Generation Partnership Project (3GPP) Long Term Evolution (LTE)-Advanced, additional control feedback may be sent on control channels to accommodate MIMO and carrier aggregation. Carrier aggregation refers to transmitting data on multiple component carriers (CCs) (or cells) that are contiguously or separately located.

The downlink 108 transmission from multiple points 110 to a single user equipment (UE) 104 may be referred to as coordinated multipoint (CoMP) transmission operation. The uplink 106 transmission from a user equipment (UE) 104 to multiple reception points 110 may be referred to as coordinated multipoint (CoMP) reception operation.

In CoMP, one transmission method is joint transmission (JT) as stated by 3GPP Release-10 specification. In one configuration of JT, all participating transmission points (TPs) 110 transmit the same unencoded data. In another configuration, all the TPs 110 may transmit the same coded data and the user equipment (UE) 104 receives and combines the signals at the user equipment (UE) 104. For example, the received signals may be combined or super imposed on the user equipment (104) prior to any processing being performed by the user equipment (UE) 104.

All points 110 transmitting coordinated multipoint (CoMP) signals to a user equipment (UE) 104 may be referred to as CoMP transmission points (TPs) 110 or transmission points (TPs) 110. All points 110 receiving coordinated multipoint (CoMP) signals from a user equipment (UE) 104 may be referred to as CoMP reception points 110 or reception points 110. The point 110 may transmit a reference signal over the downlink 108 to the user equipment (UE) 104. Each of the points 110 may use a channel state information reference signal (CSI-RS) transmit module 114 to transmit the reference signal to the user equipment (UE) 104.

Different types of reference signals may be used by the points 110. For example, points 110 may use cell-specific reference signals (CRS), multimedia broadcast over a single frequency network (MBSFN) reference signals, UE-specific reference signals (e.g., a demodulation reference signal (DM-RS)), positioning reference signals (PRS) and channel state information reference signals channel state information reference signal (CSI-RS). In Release-10 of 3GPP, there is one reference signal transmitted per downlink 108 antenna port.

The frequency bandwidth may be partitioned in subcarriers with equal bandwidth. The set of subcarriers may be denoted by SC={sc₁, sc₂, . . . , scₖ}. Time may be divided into intervals with equal durations known as the symbol period. In 3GPP Release-8 and later releases, the temporal duration of a time-frequency resource grid is 10 milliseconds (ms) (referred to as one radio frame). One radio frame may include 10 subframes, each with a duration of 1 ms, which is the duration of transmission in the uplink 106 and/or downlink 108. Every subframe may be divided into two slots, each with a duration of 0.5 ms. The set of time intervals may be denoted by T={T₁, T₂, . . . , T_{L}}. The frequency-time resource grid may then be defined as the Cartesian product of SC×T={(scₖ, Tₗ), k=1, . . . , K and l=1, . . . , L}.

The minimum amount of resource that can be allocated for the transmission of information in the uplink 106 or downlink 108 in any given subframe is two resource blocks (RBs), with one RB at each slot. Each slot may be divided into 7 symbols. The frequency domain may be divided into bands with a 15 kilohertz (kHz) width, referred to as a subcarrier. In other words, one RB has a duration of 0.5 ms (7 symbols or one slot) in the time domain and a bandwidth of 12 subcarriers (180 kHz) in the frequency domain. One resource element has a duration of one symbol in the time domain and the bandwidth of one subcarrier in the frequency domain. Additionally, at any given subframe, a maximum of two RBs (one RB at each slot) can be used by a given user equipment (UE) 104 for the transmission of uplink control information (UCI) in the physical uplink control channel (PUCCH).

The points 110 participating in the transmission of reference signals to the user equipment (UE) 104 may belong to the coordinated multipoint (CoMP) measurement set. The coordinated multipoint (CoMP) measurement set may be defined as the set of points 110 about which channel state/statistical information related to their link to the user equipment (UE) 104 is measured and/or reported. The transmission of reference signals in the downlink 108 may or may not occur in a coordinated multipoint (CoMP) transmission setting.

As used herein, a cooperating set refers to a set of geographically and/or virtually separated points 110 directly and/or indirectly participating in data transmission to a user equipment (UE) 104 in a time-frequency resource and/or data reception from a user equipment (UE) 104 in a time-frequency resource. The set of transmission and/or reception points 110 is a subset of the cooperating set. The cooperating set may or may not be transparent to the user equipment (UE) 104.

The user equipment (UE) 104 may include one or more channel state information (CSI) modules 150. For example, each component carrier (CC) may have a channel state information (CSI) module 150.

The channel state information (CSI) module 150 may include one or more channel state information (CSI) configuration modules 152, one or more channel state information (CSI) measurement modules 154, one or more channel state information (CSI) report generation modules 156, one or more channel state information (CSI) report configuration modules 158 and a channel state information (CSI) report collision resolution modules 160.

The channel state information (CSI) configuration module 152 may receive a CSI-RS configuration from eNode B 102. The CSI-RS configuration includes CSI-RS sequence, periodicity, antenna port from which the CSI-RS is transmitted and the pattern of resource elements occupied by the CSI-RS symbols. A configured CSI-RS with a particular configuration is referred to as CSI-RS resource. The reference signal sequence of a configured CSI-RS resource is transmitted on a carrier, or component carrier, occupying the time and frequency resources determined by the CSI-RS configuration.

The CSI-RS configuration may inform the user equipment (UE) 104 about the configuration of the CSI-RS received at the user equipment (UE) 104. For example, if there were multiple eNode Bs 102 using the same component carrier (CC) or cell, as may be the case with coordinated multipoint (CoMP) measurement, then each channel state information (CSI) configuration module 152 may receive a CSI-RS configuration and may apply the CSI-RS configuration to the received CSI-RS signal. In other words, multiple CSI-RS may be configured. The CSI-RS configuration may be performed by radio resource control (RRC) signaling. In general, the serving eNode B 102 configures the user equipment (UE) 104 with one or more CSI-RS in a given carrier component. The association of CSI-RS to other eNode Bs and/or other transmission points might be transparent to the user equipment (UE) 104. One parameter that is used for configuring CSI-RS resources is the identification number associated to a cell, known as the cell-ID. All the configured CSI-RS may or may not belong to the same serving cell. In other words, one or more CSI-RS resources may be configured with cell-ID(s) different from the user equipment's (user equipment (UE's) serving cell cell-ID. In one configuration, CSI-RS are indexed. The CSI-RS index may be used for prioritization.

As another example, the channel state information (CSI) module 150 may have two channel state information (CSI) configuration modules 152 that each include a CSI-RS configuration (e.g., CSI-RS 1 configuration and CSI-RS 2 configuration).

The channel state information (CSI) measurement module 154 may measure the channel state information (CSI) for each configured CSI-RS. For example, CSI-RS1 may be transmitted according to the periodicity and resource elements pattern as indicated by CSI-RS 1 configuration. In other words, at the proper time, channel state information (CSI) measurement module 154 may measure the channel state information (CSI) based on the received symbols on the resource elements on which the CSI-RS1 is transmitted. In this way, the user equipment (UE) 104 may obtain a channel state information (CSI) measurement for each CSI-RS. Additionally, the user equipment (UE) 104 may be able to obtain multiple CSI measurements when multiple CSI-RS are configured. The CSI report configuration may identify which CSI-RS(s) should be measured and/or reported In Release 10 radio resource control (RRC) specification, the CSI report configuration is referred to as CQIReportConfig.

The channel state information (CSI) report generation module 156 may generate channel state information (CSI) reports. The channel state information (CSI) reports may be generated according to a channel state information (CSI) report configuration, which is set by the channel state information (CSI) report configuration module 158. The channel state information (CSI) reports may be sent back to the eNode B 102 having one or more transmission points 110. Thus, in the case of coordinated multipoint (CoMP) transmissions multiple channel state information (CSI) reports may need to be generated and sent back to the serving eNode B 102 (or central scheduler). For each serving cell or each component carrier, there may be one or more channel state information (CSI) report generation modules 156. The channel state information (CSI) report generation modules 156 may be derived by a CSI report configuration, which may be set by the CSI report configuration module 158. One channel state information (CSI) report generation module 156 may correspond to the one or more CSI-RS(s) depending on CSI report configuration. The CSI report configuration, set by the CSI report configuration module 158, may identify which CSI-RS(s) should correspond to the channel state information (CSI) report generation module 156. For example, if there are two CSI Report configurations, for the same carrier (or component carrier, or carrier frequency) or for the same serving cell, then there will be at least two channel state information (CSI) report generation modules 156. One channel state information (CSI) report generation module 156 will correspond with CSI Report Configuration 1. Another channel state information (CSI) report generation module 156 will correspond with CSI Report Configuration 2.

The CSI report generation module 156 may generate CSI reports from CSI measurements performed by the CSI measurement module 154. The CSI reports may be based on the CSI report configuration, which may be set by the CSI report configuration module 158. It should be noted the channel state information (CSI) report may be based on a variety of channel state information (CSI) measurements. For example, the channel state information (CSI) report configuration may be based on channel quality indicators (CQI). In other words, The CSI report may be a CQI report.

Each channel state information (CSI) report configuration may include information about what should be reported and when it should be reported. For example, the channel state information (CSI) report configuration may set the periodicity for reporting a channel quality indication (CQI) and a precoding matrix indication (PMI) as well as the periodicity for reporting the rank indication (RI). For instance, the channel state information (CSI) report configuration may indicates that channel quality indications (CQI) should be reported every 5 milliseconds (ms) and rank indications (RI) should be reported every 20 milliseconds (ms). Each channel state information (CSI) report configuration may also include information about which CSI-RS(s) should be reported.

The channel state information (CSI) report generation module 156 may generate reports based on channel state information (CSI) measurement. Each generated report is identified by a report type (also referred as to PUCCH reporting type, PUCCH CSI reporting type, CSI reporting type, etc.). A report type indicates a specific combination of channel state information (CSI) information to be reported. For example, one type, denoted by TypeA, may include wideband CQI and PMI and another type, denoted by TypeB, may include RI. At a given time, the channel state information (CSI) report configuration determines what should be reported. Because different measurements (such as CQI, PMI and RI) may have different periodicities, two or more types may be chosen to be reported at the same time slot. This may cause a collision among the transmission schedule of multiple CSI reports. For example, if the channel state information (CSI) report configuration indicates that channel quality indications (CQI) should be reported every 5 milliseconds (ms) and rank indications (RI) should be reported every 20 milliseconds (ms), there will be a collision every 20 milliseconds (ms) both indications are being reported.

In 3GPP Release-10 specifications, the user equipment (UE) 104 is configured with only one CSI-RS with non-zero power for estimating the channel state information of a given component carrier and has only one channel state information (CSI) report generation module 156 corresponding to the configured CSI-RS. In 3GPP Release-11 specification and future releases of 3GPP specifications there might be more than one CSI-RS configuration and CSI-RS resource received by the user equipment (UE) 104 in any given component carrier. Thus, it may be beneficial to employ multiple channel state information (CSI) report generation modules 156 for each serving cell.

In addition, in 3GPP Release-11 specification and future releases of 3GPP specifications, coordinated multipoint (CoMP) operation may introduce more than one CSI-RS configuration. In other words, there may be multiple measurements, one for each CSI-RS and possibly an aggregated measurement, measuring the channel state information (CSI) of the effective channel obtained by combining all or a subset of the channels estimated by the configured CSI-RSs. Depending on the situation, there might be one or more channel state information (CSI) reports that are scheduled to be reported and/or transmitted at a given subframe. The colliding channel state information (CSI) reports might belong to the same measurement corresponding to a single CSI-RS, to different CSI-RSs or to aggregated measurement (e.g., a channel state information measurement performed on combination of the estimated channels by different CSI-RSs, or the CSI measurement of a CSI-RS that is transmitted from multiple points). Thus, various systems and methods relating to collision resolution will be described herein.

The channel state information (CSI) report collision resolution module 160 may resolve collision between channel state information (CSI) reports in the same serving cell. Note that the serving cell in this content (CoMP CSI measurement) is referring to a component carrier. In particular, in one implementation of CoMP, CSI-RS1 may be transmitted on the component carrier 1 from the user equipment's (UE) serving cell and CSI-RS2 may be transmitted on the same component carrier 1 from the user equipment's (UE) neighboring cell, which has a different cell-ID. Note that as long as the user equipment (UE) 104 is not aware of the association between CSI-RS and the cell, the measurement and reporting could be agnostic and transparent to such association. The output of the channel state information (CSI) report collision resolution module 160 may be a single channel state information (CSI) report to be fed back. The channel state information (CSI) report collision resolution module 160 may resolve collision based on various prioritizations, such as reporting-type, reporting-configuration and/or the serving cell index. The channel state information (CSI) report collision resolution module 160 may also resolve collisions between channel state information (CSI) reports from different serving cells, or different component carriers. In this way, collisions may be resolved within each serving cell and among multiple serving cells within the user equipment (UE) 104.

In Release 11, the CSI report configuration module 158 and the CSI report generation module 156 may or may not be part of the CSI report collision resolution module 160. The CSI report collision resolution module may include a CSI process index (which may also be referred to as a process index, a process ID or a CSI process ID), a CSI-RS ID (identity) and a CSI-IM ID (CSI Interference Measurement Identity). The CSI process index may be used for collision resolution. The eNode B 102a may send a CSI process configuration the UE via RRC dedicated signaling to configure the UE with CSI processes for each serving cell. The CSI process configuration may be performed by RRC signaling.

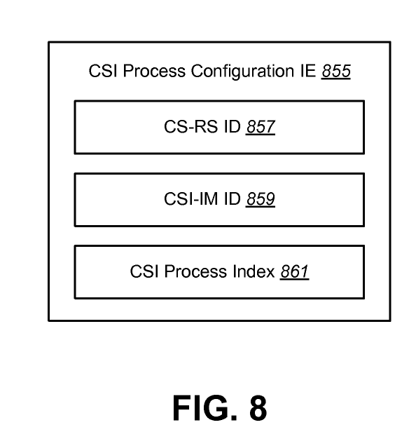

In Release 11, CSI Processes are defined. Each CSI Process may be configured at the UE by a CSI Process Configuration IE. The CSI Process Configuration IE is discussed in additional detail below in relation to FIG. 8. The CSI Process configuration IE may include a channel state information reference signal identity (CSI-RS ID), a channel state information interference measurement resource identity (CSI-IM ID) and a CSI Process ID (CSIProcessIndex). However, the CSI process configuration IE may not be defined for Release 8-10 CSI.

In Release 11, the CSI-RS ID may be defined and configured in a CSI-RS configuration IE and the CSI-IM ID may be defined and configured in a CSI-IM configuration IE. The CSI process configuration may refer to the CSI-RS ID and the CSI-IM ID. The CSI process configuration also includes a CSI Process ID to link the CSI-RS ID, the CSI-IM ID and the CSI Process. However, CRS or Release 10 CSI-RS does not include a CSI-RS ID. Furthermore, Release 8-10 does not support CSI-IM. Thus, at least the CSI Process ID needs to be defined for Release 8-10 CSI in order to configure a CSI process.

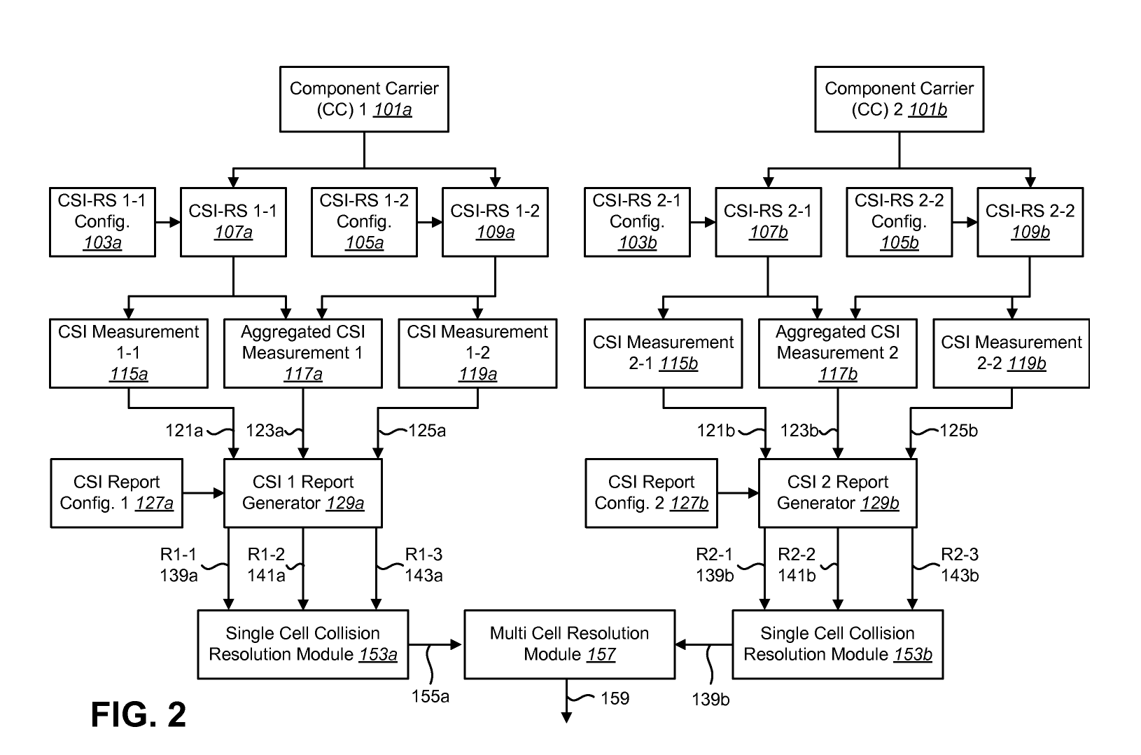

FIG. 2 is a block diagram illustrating one configuration of CSI-RS resources, measurements and reporting in a user equipment (UE) 104 serving cell. Each CSI-RS (e.g., CSI-RS 1-1 107a and CSI-RS 1-2 109a) may correspond with a CSI-RS configuration (CSI-RS configuration 1-1 103a and CSI-RS configuration 1-2 105a, respectively). The CSI-RS configuration may include CSI-RS sequence, periodicity, antenna port from which the CSI-RS is transmitted and the pattern of resource elements occupied by the CSI-RS symbols and may be set by the eNode B 102. The CSI-RS configuration may inform the user equipment (UE) 104 about the configuration of the received CSI-RS (e.g., CSI-RS 1-1 107a and CSI-RS 1-2 109a). For example, CSI-RS 1-1 107a may be transmitted by the eNode B 102 according to the periodicity and resource elements pattern as indicated by CSI-RS 1-1 Additionally, if multiple eNode Bs 102 or multiple cells, including one serving cell and one or more neighboring cells, use the same component carrier (CC) 101a, then for each configured CSI-RS (e.g., CSI-RS 1-1 107a and CSI-RS 1-2 109a) the user equipment (UE) 104 may receive a CSI-RS configuration (e.g., CSI-RS configuration 1-1 103a and CSI-RS configuration 1-2 105a) via RRC signaling from the eNode B 102 and may apply the CSI-RS configuration (e.g., CSI-RS configuration 1-1 103a and CSI-RS configuration 1-2 105a) to the received signal (e.g., CSI-RS 1-1 107a and CSI-RS 1-2 109a) in order to perform the channel state information measurement, synchronization and/or demodulation.

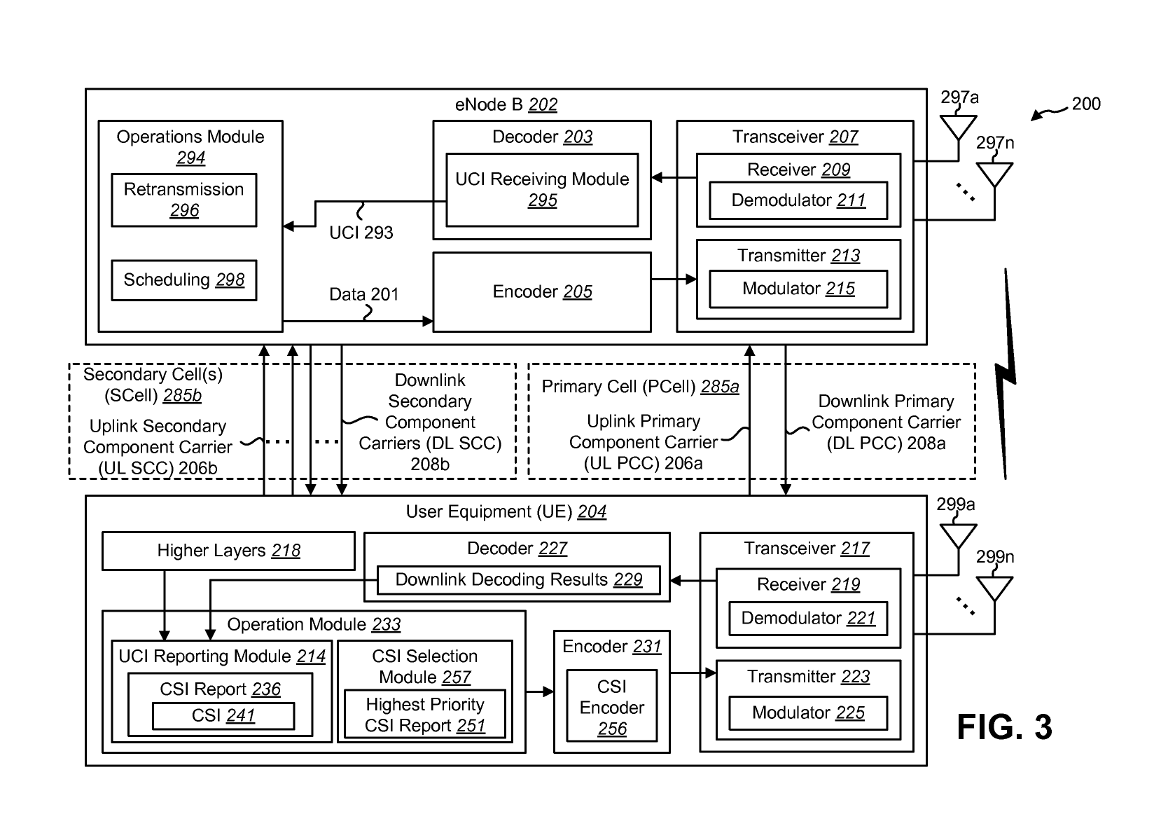

FIG. 3 is a block diagram illustrating a wireless communication system 200 using uplink control information (UCI) multiplexing. An eNode B 202 may be in wireless communication with one or more user equipments (UEs) 204. The eNode B 202 may be an example of the eNode B 102 described in connection with FIG. 1. The eNode B 202 may be part of a coordinated multipoint (CoMP) system. For instance, the eNode B 202 may be a serving eNode B 102a or a cooperating eNode B 102b.

The user equipment (UE) 204 may be an example of the user equipment (UE) 104 described in connection with FIG. 1. For example, the user equipment (UE) 204 may include an uplink channel information (UCI) reporting module 214. The UCI reporting module 214 may include a CSI report 236 and channel state information (CSI) 241. The UCI reporting module 214 of FIG. 3 may be one example of and/or include the CSI module 150 of FIG. 1. For example, the CSI report generation module 156 of FIG. 1 may generate the CSI report 236 of FIG. 3.

The user equipment (UE) 204 communicates with an eNode B 202 using one or more antenna ports, which may be realized by one or more physical antennas 299a-n. The user equipment (UE) 204 may include a transceiver 217, a decoder 227, an encoder 231 and an operations module 233. The transceiver 217 may include a receiver 219 and a transmitter 223. The receiver 219 may receive signals from the eNode B 202 using one or more antenna ports, which may be realized by one or more physical antennas 299a-n. For example, the receiver 219 may receive and demodulate received signals using a demodulator 221. The transmitter 223 may transmit signals to the eNode B 202 using one or more antenna ports, which may be realized by one or more physical antennas 299a-n. For example, the transmitter 223 may modulate signals using a modulator 225 and transmit the modulated signals.

The receiver 219 may provide a demodulated signal to the decoder 227. The user equipment (UE) 204 may use the decoder 227 to decode signals and make downlink decoding results 229. The downlink decoding results 229 may indicate whether data was received correctly. For example, the downlink decoding results 229 may indicate whether a packet was correctly or erroneously received (i.e., positive acknowledgement, negative acknowledgement or discontinuous transmission (no signal)). In one configuration, the receiver 219 may receive one or more coordinated multipoint (CoMP) transmitting signals. For example, the user equipment (UE) 204 may include multiple component carrier 101 and each component carrier 101 may receive signals from one or more transmission points 110 and the cells associated to the component carrier 101 from different transmission points may represent a single serving cell, having the same cell-ID, or they may have different cell-ID in which one cell is referred to as serving cell and other cells are referred to as neighboring cell. Also note that in case that there are one serving cell and one or more neighboring cell, all cells may be process in a single eNode B 102 or in more than one eNode B 102a-b.

The operations module 233 may be a software and/or hardware module used to control user equipment (UE) 204 communications. For example, the operations module 233 may determine when the user equipment (UE) 204 requires resources to communicate with the eNode B 202.

The user equipment (UE) 204 may transmit uplink control information (UCI) to an eNode B 202 on the uplink. The uplink control information (UCI) may be channel state information (CSI) 241 and may include a channel quality indicator (CQI), a precoding matrix indicator (PMI), precoding type indication (PTI), rank indication (RI), a scheduling request (SR), etc. The eNodeB may determine/assume that the UE sets a CSI process index and performs CSI report prioritization and sends the UCI based on the prioritization.

In Release-8, Release-9 and Release-10 of 3GPP, each user equipment (UE) 204 is configured with a cell specific CSI-RS configuration with non-zero power. Each CSI-RS configuration determines the reference signal sequence, the periodicity of the transmission of the reference signal, the resource elements allocated for transmission of the reference signal and the antenna port allocated for the transmission of the reference signal. In addition, each user equipment (UE) 204 reporting parameters are configured in a UE-specific way. The reporting configuration determines the periodicity of each CSI measurement (e.g., CQI/PMI/PTI/RI)

In 3GPP LTE Release-10 (LTE-A or Advanced EUTRAN), carrier aggregation was introduced. Carrier aggregation may also be referred to as cell aggregation. Carrier aggregation is supported in both the uplink and the downlink. Each component carrier (CC) 206, 208 or cell 285 may have a transmission bandwidth of up to 110 resource blocks (i.e., up to 20 megahertz (MHz)). In carrier aggregation, two or more component carriers (CCs) 206, 208 are aggregated to support wider transmission bandwidths up to one hundred megahertz (MHz). A user equipment (UE) 204 may simultaneously receive and/or transmit on one or multiple component carriers (CCs) 206, 208, depending on the capabilities of the user equipment (UE) 204.

If two different (geographically separated) TPs 110 serve the same user equipment (UE) 204 in the same carrier 206, it is referred to as Coordinated Multipoint (CoMP) Transmission. The downlink transmission from two different TPs 110 may or may not have the same cell-ID. If they do not have the same cell-ID then one of them is the serving cell and the other is a neighboring cell. When the transmission/reception points have the same cell IDs as the macrocell 657, it is commonly understood that all the transmission points transmit the same cell-specific reference signal (CRS) but can transmit different channel state information reference signals (CSI-RSs).

When multiple channel state information (CSI) reports 236 from a single component carrier (CC) 208 (or cell 285) are scheduled to be reported in the same subframe, a collision will occur. Additionally, different types of channel state information (CSI) 241 from different component carriers (CC) 206 scheduled to be reported in the same subframe will also cause a collision. In other words, user equipment (UE) 204 that has multiple uplink control information (UCI) elements for transmission may experience a collision. Some collision resolution procedures have already been defined in 3GPP Release-10 specifications. Additional collision resolution procedures in 3GPP Release-11 specification and future releases of 3GPP may be needed. For example, in Coordinated Multipoint (CoMP) transmissions, collision resolution due to new Uplink Control Information (UCI) may need to be specified.

The operations module 294 may include a retransmission module 296 and a scheduling module 298. The retransmission module 296 may determine which packets to retransmit (if any) based on the uplink control information (UCI) 293. The scheduling module 298 may be used by the eNode B 202 to schedule communication resources (e.g., bandwidth, time slots, frequency channels, spatial channels, etc.). The scheduling module 298 may use the uplink control information (UCI) 293 to determine whether (and when) to schedule communication resources for the user equipment (UE) 204.

One benefit of using carrier aggregation is that additional downlink 108 and/or uplink 106 data may be transmitted. As a result of the additional downlink data, additional uplink control information (UCI) 293 may be needed.

A channel state information (CSI) report 236 may be generated for each component carrier (CC) 206, 208 or cell 285. In Release-10, periodic channel state information (CSI) 241 reporting for up to five downlink component carriers (CCs) 208 (or cells 285) may be supported.

A channel state information (CSI) report 236 may be referred to as a rank indication (RI) report if the channel state information (CSI) report 236 only includes rank indication (RI). A channel state information (CSI) report 236 may be referred to as a channel quality indicator (CQI) report if the channel state information (CSI) report 236 only includes a channel quality indicator (CQI). A channel state information (CSI) report 236 may be referred to as a precoding matrix indicator (PMI) report if the channel state information (CSI) report 236 only includes a precoding matrix indicator (PMI). A channel state information (CSI) report 236 may be referred to as a precoding type indicator (PTI) report if the channel state information (CSI) report 236 only includes a precoding type indicator (PTI).

When channel state information (CSI) reports 236 collide with each other, the collision may be resolved by prioritizing the channel state information (CSI) reports 236. The prioritization can be based on content (or type) as defined in Release-11, based on the CSI Process index and based on the serving cell index, as defined in Release-11.

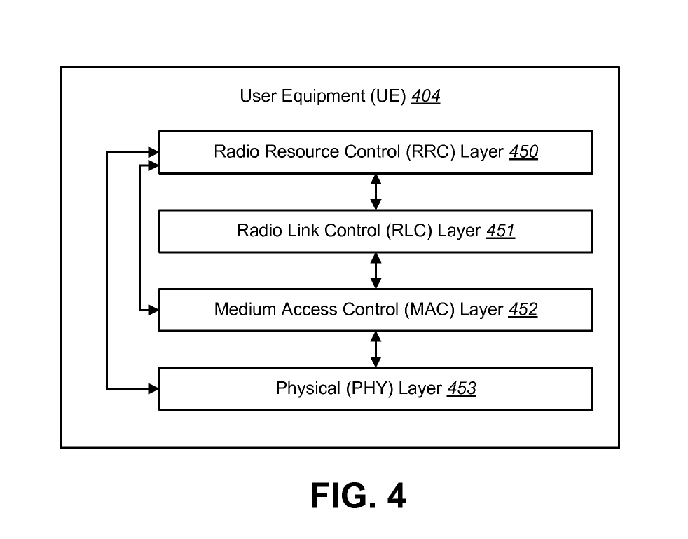

FIG. 4 is a block diagram illustrating the layers used by a user equipment (UE) 404. The user equipment (UE) 404 of FIG. 4 may be one configuration of the user equipment (UE) 104 of FIG. 1. The user equipment (UE) 404 may include a radio resource control (RRC) layer 450, a radio link control (RLC) layer 451, a medium access control (MAC) layer 452 and a physical (PHY) layer 453. These layers may be referred to as higher layers 218. The user equipment (UE) 404 may include additional layers not shown in FIG. 4.

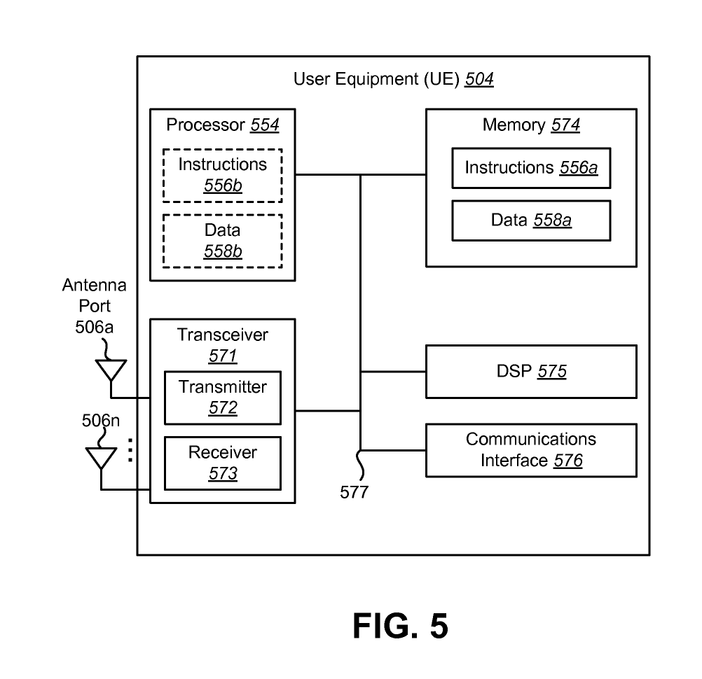

FIG. 5 illustrates various components that may be utilized in a user equipment (UE) 504. The user equipment (UE) 504 may be utilized as the user equipment (UE) 104 illustrated previously. The user equipment (UE) 504 includes a processor 554 that controls operation of the user equipment (UE) 504. The processor 554 may also be referred to as a CPU. Memory 574, which may include both read-only memory (ROM), random access memory (RAM) or any type of device that may store information, provides instructions 556a and data 558a to the processor 554. A portion of the memory 574 may also include non-volatile random access memory (NVRAM). Instructions 556b and data 558b may also reside in the processor 554. Instructions 556b and/or data 558b loaded into the processor 554 may also include instructions 556a and/or data 558a from memory 574 that were loaded for execution or processing by the processor 554. The instructions 556b may be executed by the processor 554 to implement the systems and methods disclosed herein.

The user equipment (UE) 504 may also include a housing that includes a transmitter 572 and a receiver 573 to allow transmission and reception of data. The transmitter 572 and receiver 573 may be combined into a transceiver 571. One or more antennas 506a-n are attached to the housing and electrically coupled to the transceiver 571. An antenna port may be realized by one or more antennas.

The various components of the user equipment (UE) 504 are coupled by a bus system 577, which may include a power bus, a control signal bus, and a status signal bus, in addition to a data bus. However, for the sake of clarity, the various buses are illustrated in FIG. 5 as the bus system 577. The user equipment (UE) 504 may also include a digital signal processor (DSP) 575 for use in processing signals. The user equipment (UE) 504 may also include a communications interface 576 that provides user access to the functions of the user equipment (UE) 504. The user equipment (UE) 504 illustrated in FIG. 5 is a functional block diagram rather than a listing of specific components.

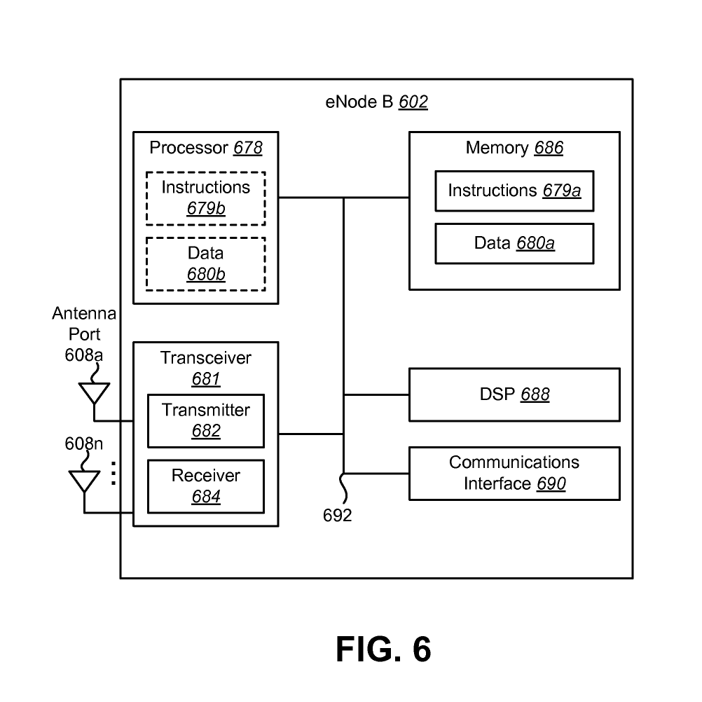

FIG. 6 illustrates various components that may be utilized in an eNode B 602. The eNode B 602 may be utilized as the eNode B 102 illustrated previously. The eNode B 602 may include components that are similar to the components discussed above in relation to the user equipment (UE) 504, including a processor 678, memory 686 that provides instructions 679a and data 680a to the processor 678, instructions 679b and data 680b that may reside in or be loaded into the processor 678, a housing that includes a transmitter 682 and a receiver 684 (which may be combined into a transceiver 681), one or more antenna ports 608a-n electrically coupled to the transceiver 681, a bus system 692, a DSP 688 for use in processing signals, a communications interface 690 and so forth.

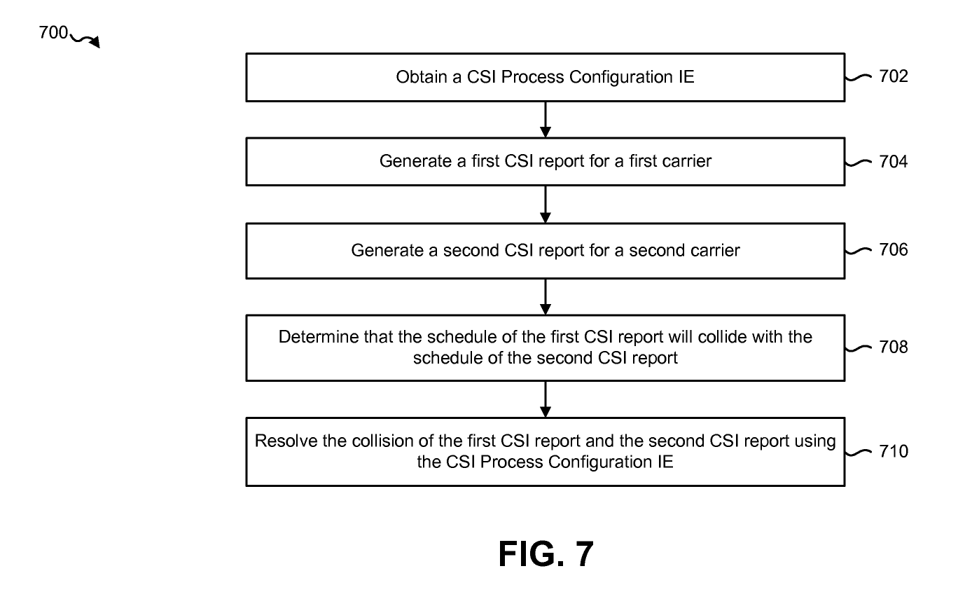

FIG. 7 is a flow diagram of a method 700 for reporting UCI on a UE. More specifically, the method may provide collision resolution using the CSI Process.

Each UE 104 may be configured with non-zero power channel state information reference signal (NZP CSI-RS), which is referred to as the CSI-RS. The configuration is accomplished using UE dedicated signaling at the radio resource control (RRC) layer. The information for the configuration may be grouped into information elements (lEs) for each configuration. Each newer release of the specification (e.g., Release 10, Release 11) may add another field to the previous release IE, which is not applicable to legacy UEs 104 (UEs 104 that do not support the new release and were manufactured before the new release). New IEs may also be introduced to support required configurations. One example of a CSI-RS configuration IE in Release 10 is given below:

| | |
|---|---|
| -- ASN1START | |
| CSI-RS-Config-r10 ::= | SEQUENCE { |
| csi-RS-r10 | CHOICE { |

| | |
|---|---|
| release | NULL, |
| setup | SEQUENCE { |

| | |
|---|---|
| antennaPortsCount-r10 | ENUMERATED {an1, an2, an4, an8}, |
| resourceConfig-r10 | INTEGER (0..31), |
| subframeConfig-r10 | INTEGER (0..154), |
| p-C-r10 | INTEGER (−8..15) |
| } | |

| | | |
|---|---|---|
| } | OPTIONAL, | -- |
| Need ON | | |

| | |
|---|---|
| zeroTxPowerCSI-RS-r10 | CHOICE { |
| release | NULL, |
| setup | SEQUENCE { |

| | |
|---|---|
| zeroTxPowerResourceConfigList-r10 | BIT STRING (SIZE (16)), |
| zeroTxPowerSubframeConfig-r10 | INTEGER (0..154) |
| } | |

| | | |
|---|---|---|
| } | OPTIONAL | -- |
| Need ON | | |
| } | | |
| -- ASN1STOP | | |

The description of fields in the CSI-RS configuration IE is given below in Table 3:

TABLE 3
CSI-RS-Config field descriptions

antennaPortsCount
Parameter represents the number of antenna ports used for transmission of
CSI reference signals where an1 corresponds to 1, an2 to 2 antenna ports
etc. see TS 36.211 [21, 6.10.5].
p-C
Parameter: P_{c}, see TS 36.213 [23, 7.2.5].
resourceConfig
Parameter: CSI reference signal configuration, see TS 36.211 [21, table
6.10.5.2-1 and 6.10.5.2-2].
subframeConfig
Parameter: I_{CSI-RS}, see TS 36.211 [21, table 6.10.5.3-1].
zeroTxPowerResourceConfigList
Parameter: ZeroPowerCSI-RS, see TS 36.211 [21, 6.10.5.2].
zeroTxPowerSubframeConfig
Parameter: I_{CSI-RS}, see TS 36.211 [21, table 6.10.5.3-1].

An example of a CQI report configuration IE in Release 10 is given below:

-- ASN1START

| | |
|---|---|
| CQI-ReportConfig ::= | SEQUENCE { |

| | |
|---|---|
| cqi-ReportModeAperiodic | CQI-ReportModeAperiodic OPTIONAL, |
| -- Need OR | |

| | |
|---|---|
| nomPDSCH-RS-EPRE-Offset | INTEGER (−1..6), |

| | | |
|---|---|---|
| cqi-ReportPeriodic | CQI-ReportPeriodic OPTIONAL | -- |
| Need ON | | |
| } | | |

| | |
|---|---|
| CQI-ReportConfig-v920 ::= | SEQUENCE { |

| | | | |
|---|---|---|---|
| cqi-Mask-r9 | ENUMERATED {setup} | OPTIONAL, | -- |
| Cond cqi-Setup | | | |

| | | | |
|---|---|---|---|
| pmi-RI-Report-r9 | ENUMERATED {setup} | OPTIONAL | -- Cond |
| PMIRI | | | |
| } | | | |

CQI-ReportConfig-r10 ::=SEQUENCE {

| | | |
|---|---|---|
| cqi-ReportAperiodic-r10 | CQI-ReportAperiodic-r10 | OPTIONAL, - |
| - Need ON | | |
| nomPDSCH-RS-EPRE-Offset | INTEGER (−1..6), | |
| cqi-ReportPeriodic-r10 | CQI-ReportPeriodic-r10 | OPTIONAL, - |
| - Need ON | | |

| | | |
|---|---|---|
| pmi-RI-Report-r9 | ENUMERATED {setup} | OPTIONAL, - |
| - Cond PMIRIPCell | | |

| | |
|---|---|
| csi-SubframePatternConfig-r10 | CHOICE { |
| release | NULL, |

| | |
|---|---|
| setup | SEQUENCE { |

| | |
|---|---|
| csi-MeasSubframeSet1-r10 | MeasSubframePattern-r10, |
| csi-MeasSubframeSet2-r10 | MeasSubframePattern-r10 |
| } | |

| | | |
|---|---|---|
| } | OPTIONAL | -- Need |
| ON | | |
| } | | |

| | |
|---|---|
| CQI-ReportConfigSCell-r10 ::= | SEQUENCE { |
| cqi-ReportModeAperiodic-r10 | CQI-ReportModeAperiodic OPTIONAL, |
| -- Need OR | |

| | |
|---|---|
| nomPDSCH-RS-EPRE-Offset-r10 | INTEGER (−1..6), |

| | | |
|---|---|---|
| cqi-ReportPeriodicSCell-r10 | CQI-ReportPeriodic-r10 | OPTIONAL, - |
| - Need ON | | |

| | | |
|---|---|---|
| pmi-RI-Report-r10 | ENUMERATED {setup} | OPTIONAL |
| -- Cond PMIRISCell | | |
| } | | |

A UE 104 that is configured with transmission mode 10 for any serving cells may be configured with one or more CSI processes per serving cell by higher layers. Transmission mode defines a mode of PDSCH transmission (currently TM1 through TM10). Each CSI process may be associated with a CSI-RS resource (defined in Section 7.2.5 of 36.213 PHY layer procedures) and a CSI-interference measurement (CSI-IM) resource (defined in Section 7.2.6 of 36.213 PHY layer procedures). A CSI reported by the UE 104 may correspond to a CSI process configured by higher layers. Section 7.2.5 and Section 7.2.6 of 36.213 PHY layer procedures are given below for reference.

### 7.2.5 Channel-State Information-Reference Signal (CSI-RS) Definition

A UE can be configured with one or more CSI-RS resource configuration per serving cell. The following parameters for CSI-RS are configured via higher layer signaling for each CSI-RS resource configuration:
Number of CSI-RS ports. The allowable values and port mapping are given in Section 6.10.5 of [Error! Reference source not found.].
CSI RS Configuration (see Table 6.10.5.2-1 and Table 6.10.5.2-2 in [Error! Reference source not found.])
CSI RS subframe configuration I_{CSI-RS}. The allowable values are given in Section 6.10.5.3 of [Error! Reference source not found.].
UE assumption on reference PDSCH transmitted power for CSI feedback P_{c}. P_{c}
   is the assumed ratio of PDSCH EPRE to CSI-RS EPRE when UE derives CSI feedback and takes values in the range of [−8, 15] dB with 1 dB step size, where the PDSCH EPRE corresponds to the symbols for which the ratio of the PDSCH EPRE to the cell-specific RS EPRE is denoted by ρ_{A}, as specified in Table 5.2-2 and Table 5.2-3.
Pseudo-random sequence generator parameter, n_{ID}. The allowable values are given in [[0085]].

### 7.2.6 Channel-State Information-Interference Measurement (CSI-IM) Resource Definition

A UE can be configured with one or more CSI-IM resource configuration per serving cell. The following parameters are configured via higher layer signaling for each CSI-IM resource configuration:
Zero-power CSI RS Configuration (see Table 6.10.5.2-1 and Table 6.10.5.2-2 in [3])
Zero-power CSI RS subframe configuration I_{CSI-RS}. The allowable values are given in Section 6.10.5.3 of [3].

In 7.2.5 and 7.2.6, [2] refers to 3GPP TS 36.211: “Evolved Universal Terrestrial Radio Access (E-UTRA); Physical Channels and Modulation” and [3] refers to 3GPP TS36.331, “Evolved Universal Terrestrial Radio Access (E-UTRA); Radio Resource Control (RRC) protocol specification.”

The UE 104 may be configured with carrier aggregation. In carrier aggregation, each carrier may be configured independently. Therefore, it is possible for a UE 104 to use carrier aggregation where a first carrier has a Release 11 CSI-RS configuration and a Release 11 CSI Process while a second carrier has a Release 10 CSI-RS configuration and a Release 10 CSI reporting configuration (e.g., cqi-ReportConfig-r10). As another example, one of the carriers may use a Release 8, Release 9 or Release 10 reporting configuration (e.g., cqi-ReportConfig, cqi-ReportConfig-r10) for CRS. The CSI Process may not be defined for Release 10 or earlier. Therefore, the CRS or Release 10 CSI-RS configuration and Release 8-10 CSI report configuration may not include a CSI Process ID.

For transmission mode 1-8, the UE 104 may derive the channel measurements for computing CSI based on the CRS. For transmission mode 9, the UE 104 may derive the channel measurements for computing CSI based on Release 10 CSI-RS. For transmission mode 10, the UE 104 may derive the channel measurements for computing CSI based on Release 11 CSI-RS.

The UE 104 may obtain 702 a first CSI process configuration IE for a first serving cell. The UE 104 may also obtain 702 a second CSI process configuration IE for a second serving cell. As discussed above, the CSI process configuration IE may not be defined for a serving cell. If the CSI process configuration IE is not defined for a serving cell, the UE 104 may use default values for the CSI process configuration IE. Below are definitions for the CSI process configuration for Release 8-10 CSI.

If the CSI process configuration refers to CSI-RS-Config-r10 (i.e., Release 10 CSI-RS) or CRS (cell-specific reference signal), one default value (e.g., 0) may be set to the IE of the CSI-RS ID to refer to CSI-RS-Config-r10 and one default value (e.g., 0) may be set to the IE of the CSI-IM ID (i.e., no CSI-IM). The CSI process ID in the CSI process configuration may always be set to the lowest value of the CSI process ID (e.g., 0) if the CSI process does not refer to CSI-RS-Config2-r11 (i.e., if the CSI process refers to CSI-RS-Config-r10 or CRS)). The CSI process ID in the CSI process configuration may always be set to the highest value of the CSI process ID (e.g., infinity) if the CSI process does not refer to CSI-RS-Config2-r11 (i.e., if the CSI process refers to CSI-RS-Config-r10 or CRS)). Thus, the default value for the CSI-RS ID, the CSI-IM ID and/or the CSI process ID may be reserved for Release 8-10 CSI Processes. The default value may be infinity (i.e., the highest value of the CSI process ID). The infinity value for the CSI process ID as a default value can have the benefit to prioritize Release 8-10 CSI processes. The zero value for the CSI process ID as a default value may have the benefit to de-prioritize Release 8-10 CSI processes.

The CSI-RS ID field and the CSI-IM ID field may be present in the CSI Process configuration IE if the serving cell is configured with Transmission Mode 10 (TM10). Otherwise (i.e., for Transmission Mode 1-9), the CSI-RS ID field and the CSI-IM ID field are not present in the CSI Process configuration IE. If the serving cell is configured with Transmission Mode 1-9, the CSI process ID in the CSI Process configuration IE may always be set to the lowest value of the CSI process ID (e.g., 0). If the serving cell is configured with Transmission Mode 1-9, the CSI process ID in the CSI process configuration IE may always be set to the highest value of the CSI process ID (e.g., infinity).

The CSI-RS ID field and the CSI-IM ID field may be present in the CSI Process configuration IE if the serving cell is configured with a Release 11 CSI-RS configuration IE (CSI-RS-Config2-r11). If the CSI process does not refer to CSI-RS-Config2-r11 (i.e., if the CSI process refers to CSI-RS-Config-r10 or CRS), the CSI process ID in the CSI process configuration may always be set to a default value. The default value may be 0 (i.e., the lowest value of the CSI process ID). The default value may also be infinity (i.e., the highest value of the CSI process ID).

If a CSI process configuration is not included in a configuration for a serving cell, the CSI process ID for the serving cell may be set to 0 (i.e., the lowest value of CSI process ID). Thus, the default CSI process ID may be 0. If a CSI process configuration is not included in a configuration for a serving cell, the CSI process ID for the serving cell may be set to the highest value of CSI process ID (e.g., infinity). Thus, the default CSI process ID may be infinity.

The UE 104 may generate 704 a first CSI report for a first carrier corresponding to the first serving cell. The UE 104 may also generate 706 a second CSI report for a second carrier corresponding to the second serving cell. The UE 104 may then determine 708 that the schedule of the first CSI report will collide with the schedule of the second CSI report. The UE 104 may resolve 710 the collision of the first CSI report and the second CSI report using the CSI process ID.

For Release 11, it is agreed that such a collision should be resolved based on the following rules. For a given subframe, in cases of a collision of a CSI report with PUCCH reporting type 3, 5 or 6 of one serving cell with a CSI report with PUCCH reporting type 1, 1a, 2, 2a, 2b, 2c or 4 of the same serving cell, the latter CSI report (i.e., the CSI report with PUCCH reporting type 1, 1a, 2, 2a, 2b, 2c or 4) has lower priority and is dropped. In cases of a collision between CSI reports of the same serving cell with a PUCCH reporting type of the same priority, where the CSI reports correspond to different CSI processes, the CSI reports corresponding to all CSI processes except the CSI process with the lowest CSI process ID (CSI ProcessIndex) are dropped.

If the UE 104 is configured with more than one serving cell, the UE 104 may transmit a CSI report of only one serving cell in any given subframe. For a given subframe, in cases of a collision between a CSI report with PUCCH reporting type 3, 5, 6 or 2a of one serving cell and a CSI report with PUCCH reporting type 1, 1a, 2, 2b, 2c or 4 of another serving cell, the latter CSI report (i.e., the CSI report with PUCCH reporting type 1, 1a, 2, 2b, 2c or 4) has lower priority and is dropped. For a given subframe, in cases of a collision between a CSI report with PUCCH reporting type 2, 2b, 2c or 4 of one serving cell and a CSI report with PUCCH reporting type 1 or 1a of another serving cell, the latter CSI report (i.e., the CSI report with PUCCH reporting type 1 or 1a) has lower priority and is dropped.

In cases of a collision between CSI reports of different serving cells with PUCCH reporting type of the same priority, where the CSI reports correspond to CSI processes with the same CSI process IDs (CSIProccessIndex), the CSI reports of all serving cells except the serving cell with the lowest ServCellIndex are dropped. In cases of a collision between CSI reports of different serving cells with PUCCH reporting type of the same priority, where the CSI reports correspond to CSI processes with different CSI process IDs (CSIProccessIndex), the CSI reports of all serving cells except the serving cell with the CSI reports corresponding to a CSI process with the lowest CSIProcessIndex are dropped.

FIG. 8 is a block diagram illustrating one configuration of a CSI Process configuration IE 855. The CSI Process configuration IE 855 configures each CSI process at the UE 104. The CSI process configuration IE 855 may include a channel state information reference signal identity (CSI-RS ID) 857. The CSI-RS ID 857 may have a value of 1, 2 or 3. The CSI process configuration IE 855 may also include a channel state information interference measurement resource identity (CSI-IM ID) 859. The CSI-IM ID 859 may have a value of 1, 2 or 3. The CSI process configuration IE 855 may further include a CSI Process index 861 (CSIProcessIndex). The CSI process index 861, as used in collision resolution, does not exist for CRS or Release 10 CSI-RS and Release 8-10 CSI report configurations. Thus, a CSI process index 861 for Release 8-10 CSI needs to be defined.

In one configuration, a CSI process may be defined for carriers with CSI reports for CRS or Release 10 CSI-RS. The default value may be reserved for CSI-RS ID 857 and CSI IM ID 859 in the CSI process configuration. If the CSI process configuration refers to CSI-RS-Config-r10 (i.e., Release 10 CSI-RS) or CRS (cell-specific reference signal), one default value (e.g., 0) may be set to the IE of CSI-RS ID 857 to refer to CSI-RS-Config-r10 and one default value (e.g., 0) may be set to the IE of CSI-IM ID 859 (i.e., no CSI-IM). The value for the CSI process ID may be set by the eNode B 102. The CSI process ID in the CSI process configuration may always be set to the lowest value of the CSI process ID (e.g., 0) if the CSI process does not refer to CSI-RS-Config2-r11 (i.e., if the CSI process refers to CSI-RS-Config-r10 or CRS). The CSI process ID in the CSI process configuration may always be set to the lowest value of the CSI process ID (e.g., infinity) if the CSI process does not refer to CSi-RS-Config2-r11 (i.e., if the CSI process refers to CSI-RS-Config-r10 or CRS). Thus, in this method, there is no need to introduce the CSI-RS ID 857 in the CSI-RS configuration IE, nor is there a need to introduce a CSI-IM IE (the CSI-IM IE includes the CSI-IM ID 859).

The UE 104 may set a CSI process index 861 to a value received in a CSI process configuration for each serving cell. The CSI-RS configuration corresponding to a CSI-RS ID 857 for a CSI process configuration may be referred if a field for the CSI-RS ID is not set to a reserved value. If the CSI-RS ID 857 is set to a reserved value, a CRS or a CSI-RS configuration for Release 10 may be referred.

In another configuration, the CSI-RS ID 857 and the CSI-IM ID 859 fields may be optional in a CSI process configuration IE. In this configuration, a condition may be that the parameter should be configured if the serving cell is configured with Transmission Mode 10 (TM10). The CSI-RS ID 857 field and the CSI-IM ID 859 field are present in the CSI process configuration IE 855 if the serving cell is configured with Transmission Mode 10 (TM10), otherwise (i.e., for Transmission Mode 1-9), the CSI-RS ID 857 field and the CSI-IM ID 859 field are not present in the CSI process configuration IE 855. The CSI process index 861 in the CSI process configuration may always be set to the lowest value for the CSI process index 861 (e.g., 0) if the serving cell is configured with Transmission Mode 1-9. The CSI process index 861 in the CSI process configuration may always be set to the highest value for the CSI process index 861 (e.g., infinity) if the serving cell is configured with Transmission Mode 1-9.

The UE 104 may set a CSI process index 861 to a value received in a CSI process configuration for each serving cell. The UE 104 may refer a CSI-RS configuration corresponding to a CSI-RS identity for a CSI process for the CSI process configuration if a field for the CSI-RS ID 857 is present. Otherwise, the UE 104 may refer a CRS or CSI-RS configuration for Release 10.

In yet another configuration, the CSI-RS ID 857 and the CSI-IM ID 859 fields may be optional in a CSI process configuration IE 855. In this configuration, a condition may be that the parameter should be configured if the serving cell is configured with a Release 11 CSI-RS configuration IE. The CSI-RS ID 857 field and the CSI-IM ID 859 field in may be present in the CSI process configuration IE 855 if the serving cell is configured with a Release 11 CSI-RS configuration IE (CSI-RS-Config2-r11). The CSI process index 861 in the CSI process configuration may always be set to the lowest value of the CSI process index 861 (e.g., 0) if the CSI process does not refer to CSI-RS-Config2-r11 (i.e., if the CSI process refers to CSI-RS-Config-r10 or CRS). The CSI process index 861 in the CSI process configuration may always be set to the highest value of the CSI process index 861 (e.g., infinity) if the CSI process does not refer to CSI-RS-Config2-r11 (i.e., if the CSI process refers to the CSI-RS-Config-r10 or CRS).

The UE 104 may set a CSI process index 861 to a value received in a CSI process configuration for each serving cell. The UE 104 may refer a CSI-RS configuration corresponding to CSI-RS identity for a CSI process for the CSI process configuration if a field for the CSI-RS ID 857 is present. Otherwise, the UE 104 may refer a CRS or a CSI-RS configuration for Release 10.

In another configuration, the UE 104 may assign predefined CSI process index 861 values to the CSI reports generated by CRS or Release 10 CSI-RS. If the CSI process configuration is not included in a configuration for a serving cell, the CSI process index 861 in the CSI process configuration may be set to the lowest value of the CSI process index 861 (e.g., 0). Thus, the default CSI process ID may be 0. If the CSI process configuration is not included in a configuration for a serving cell, the CSI process index 861 in the CSI process configuration may be set to the highest value of the CSI process index 861 (e.g., infinity). Thus, the default CSI process ID may be infinity.

The UE 104 may set a CSI process index 861 to a value received in a CSI process configuration for each serving cell if a message the UE 104 received includes the CSI process configuration for the serving cell. If a message the UE 104 received does not include a CSI process configuration for the serving cell, the UE 104 may set a CSI process index 861 to a default value. The eNode B 102 may determine that the UE 104 sets a CSI process index 861 to a value received in a CSI process configuration for each serving cell if a message the eNode B 102 sent to the UE 104 includes the CSI process configuration for the serving cell; and sets a CSI process index 861 to a default value if a message the eNode B 102 sent to the UE 104 does not include a CSI process configuration for the serving cell.

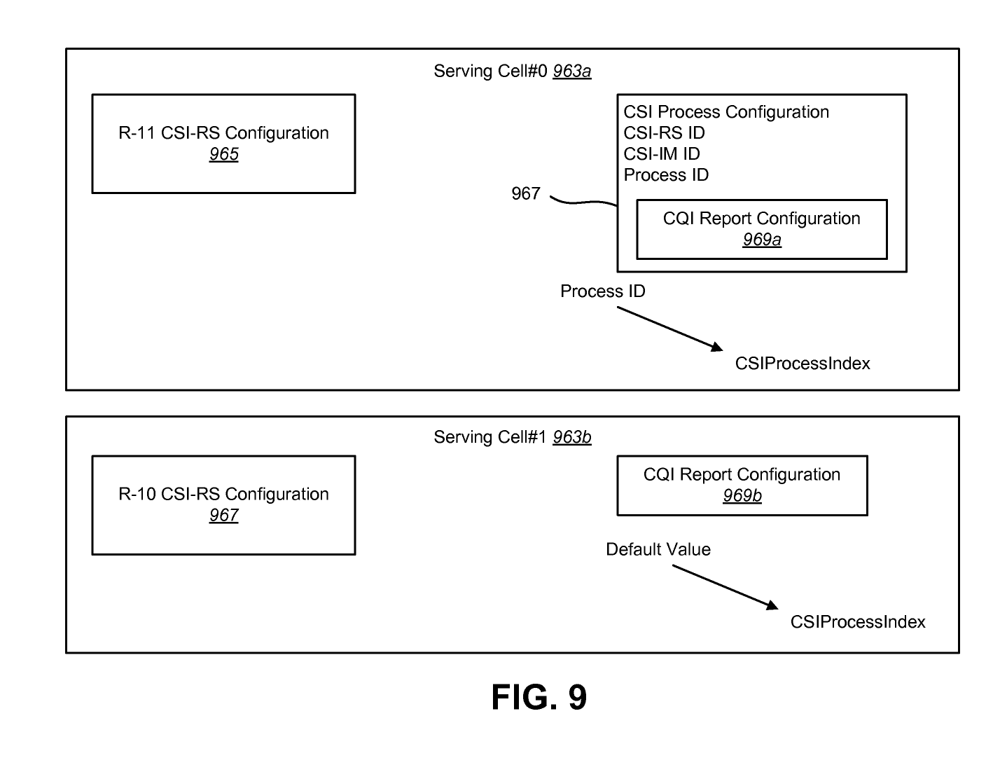

FIG. 9 is a block diagram illustrating CSI-RS configurations for multiple serving cells 963a-b. In a first serving cell 963a (Serving Cell #0), an R-11 CSI-RS configuration 965 is included. The first serving cell 963a may also include a CSI process configuration 967. The CSI process configuration 967 may include a CSI-RS ID 857, a CSI-IM ID 859 and a process ID. The process ID may correspond to the CSIProcessIndex of the first serving cell. The CSI process configuration 967 may also include a CQI report configuration 969a.

In a second serving cell 963b (Serving Cell #1), an R-10 CSI-RS configuration 967 is included. The second serving cell 963b may also include a CQI report configuration 969b with default values. Thus, a default value may be used as the CSIProcessIndex.

Unless otherwise noted, the use of ‘/’ above represents the phrase “and/or.”

The functions described herein may be implemented in hardware, software, firmware or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. In addition, “determining” can include receiving (e.g., receiving information), accessing (e.g., accessing data in a memory) and the like. Also, “determining” can include resolving, selecting, choosing, establishing and the like.

The phrase “based on” does not mean, “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method on a user equipment (UE), comprising:
determining a channel state information (CSI) report to be dropped from among multiple CSI reports of physical uplink control channel (PUCCH) reporting type of a same priority corresponding to multiple serving cells, wherein one of the CSI reports with a CSI process index received in a CSI process configuration corresponds to a serving cell configured with transmission mode 10 and another of the CSI reports corresponds to a serving cell configured with one of transmission mode 1 through 9.

2. A method on a base station, comprising:
determining that a user equipment (UE) determines a channel state information (CSI) report to be dropped from among multiple CSI reports of physical uplink control channel (PUCCH) reporting type of a same priority corresponding to multiple serving cells, wherein one of the CSI reports with a CSI process index received in a CSI process configuration corresponds to a serving cell configured with transmission mode 10 and another of the CSI reports corresponds to a serving cell configured with one of transmission mode 1 through 9.

3. A user equipment (UE), comprising:
a processor;
memory in electronic communication with the processor, wherein instructions stored in the memory are executable to:
determine a channel state information (CSI) report to be dropped from among multiple CSI reports of physical uplink control channel (PUCCH) reporting type of a same priority corresponding to multiple serving cells, wherein one of the CSI reports with a CSI process index received in a CSI process configuration corresponds to a serving cell configured with transmission mode 10 and another of the CSI reports corresponds to a serving cell configured with one of transmission mode 1 through 9.

4. A base station, comprising:
a processor;
memory in electronic communication with the processor, wherein instructions stored in the memory are executable to:
determine that a user equipment (UE) determines a channel state information (CSI) report to be dropped from among multiple CSI reports of physical uplink control channel (PUCCH) reporting type of a same priority corresponding to multiple serving cells, wherein one of the CSI reports with a CSI process index received in a CSI process configuration corresponds to a serving cell configured with transmission mode 10 and another of the CSI reports corresponds to a serving cell configured with one of transmission mode 1 through 9.
